(19) United States
(12) Patent Application Publication
(10) Pub. No.: US 2023/0242399 A1
(43) Pub. Date: Aug. 3, 2023

(54) ELECTRICITY AND HYDROGEN PRODUCTION FROM DEPLETED OIL/GAS RESERVOIRS USING AIR INJECTION AND GEOTHERMAL ENERGY HARVESTING

(71) Applicant: SAUDI ARABIAN OIL COMPANY, Dhahran (SA)

(72) Inventors: Abdulaziz S. Al-Qasim, Dammam (SA); Yuguo Wang, Dhahran (SA); Sunil Kokal, Dhahran (SA)

(73) Assignee: SAUDI ARABIAN OIL COMPANY, Dhahran (SA)

(21) Appl. No.: 17/649,236

(22) Filed: Jan. 28, 2022

(51) Int. Cl. C01B 3/50; F24T 10/30

(52) U.S. Cl. CPC C01B 3/50; F24T 10/30; F24T 2010/50

(57) ABSTRACT

The present disclosure details methods and systems for generating and recovering hydrogen from a depleted reservoir. The methods comprise several steps. Oxygen is introduced into a depleted reservoir. A fire flood is initiated, increasing temperature in the depleted reservoir and generating a gas mixture. The gas mixture is removed and transported to the surface. Energy is recovered from the gas mixture. Hydrogen is separated from the gas mixture, producing a depleted gas mixture and a hydrogen-rich gas mixture. The hydrogen-rich gas mixture is introduced into a subterranean storage formation.

The systems for generating and recovering hydrogen comprise a depleted reservoir comprising hydrocarbons, a subterranean storage formation where hydrogen gas is substantially present that is bounded on at least one side by an intermediate formation, a fluid pathway between the depleted reservoir and the subterranean storage formation, and a wellbore traversing the subterranean storage formation and the depleted reservoir.

### BACKGROUND

Various technologies involving renewable resources, carbon capture and storage, and hydrogen energy production are potentially useful for reducing emissions of greenhouse gases. One of these technologies is the harvesting of geothermal energy from subterranean formations, where heat from a subterranean formation is harvested for energy. Geothermal energy is generally sustainable and produces fewer greenhouse gas emissions than many other common energy sources.

During normal oil and gas production, the thermal energy of the crude oil, liquid condensate, or natural gas is rarely exploited for energy production; rather, produced hydrocarbons are permitted to retain the heat from their natural environment to maintain a reduced fluid viscosity. As the produced hydrocarbons cool during transport from the production well, their viscosity often increases substantially.

### SUMMARY

The present disclosure details methods and systems for generating and recovering hydrogen from a depleted reservoir. The methods comprise introducing oxygen into a depleted reservoir, initiating a fire flood in the depleted reservoir to increase temperature and generate a gas mixture, removing the gas mixture from the depleted reservoir, recovering energy from the gas mixture, separating some of the hydrogen from the gas mixture to create a depleted gas mixture and a hydrogen-rich gas mixture, and introducing the hydrogen-rich gas mixture into a subterranean storage formation.

The systems comprise a depleted reservoir comprising hydrocarbons, a subterranean storage formation where hydrogen gas is substantially present that is bounded on at least one side by an intermediate formation, a fluid pathway between the depleted reservoir and the subterranean storage formation, and a wellbore comprising a wall that traverses the subterranean storage formation and the depleted reservoir.

Other aspects and advantages of the claimed subject matter will be apparent from the following Detailed Description and the appended Claims.

### BRIEF DESCRIPTION OF DRAWINGS

FIG. 1 is a representation of a well system having a depleted reservoir and a storage formation, according to one or more embodiments.

FIG. 2 is a representation of well system having a depleted reservoir and a plurality of storage formations, according to one or more embodiments.

FIG. 3 is a representation of one embodiment of a method of hydrogen production and storage, method 1.

### DETAILED DESCRIPTION

To be a viable option for electricity production, geothermal energy typically requires high temperatures in subterranean geological formations that are close to the surface. Subterranean geological formations are underground groupings of rock sharing similar physical properties. These conditions are only present at a few locations around the world. Lower temperature subterranean geological formations are typically less useful for electricity production and are more often used as a source of energy in other such applications as heating or cooling or in desalination.

The present invention encompasses a method and a system for the production of heat and a mixture of gases including hydrogen in a hydrocarbon well. This is done by producing a fire flood in a well to cause various hydrocarbons in the well to combust and produce a mixture of gases that comprises one or more of hydrogen, carbon dioxide, carbon monoxide, water, methane, and other hydrocarbons. The hot gases allow for more efficient geothermal energy production and may be used in the production of electricity and the useful exploitation of hydrocarbons that are otherwise unviable for recovery. The produced hydrogen is separated and stored in one or more subterranean geological formations for current or future utilization. In at least one embodiment, carbon dioxide is separated and stored in one or more additional subterranean geological formations, such as for sequestering to prevent emissions, to hold for future use as a chemical feedstock, or for utilization in productive reservoirs, such as for enhanced oil recovery (EOR).

In some instances, some of the hydrocarbons may not be unrecoverable utilizing current technological means. In other instances, some of the hydrocarbons may requires extreme recovery techniques that are simply uneconomical at foreseeable market conditions. Finally, there are some hydrocarbons that are simply immobile or insoluble and will not flow through the reservoir. The embodiment methods provide a solution for all of these things by converting hydrocarbons to hot gases that are useful for generating power but also contain valuable chemicals.

In one or more embodiments, an oxygen-comprising gas mixture is introduced into a depleted reservoir. In one or more embodiments, a fire flood is initiated in the depleted reservoir proximate to where the oxygen-comprising gas mixture is introduced. The fireflood introduces heat and increases the temperature to a subsequent value that allows for the production of a product gas mixture comprising hydrogen (H₂). In some instances, the product gas mixture includes carbon dioxide (CO₂). In one or more embodiments, this product gas mixture moves through the depleted reservoir and is recovered at the surface. At the surface, in one or more embodiments, the product gas mixture is introduced into a gas turbine coupled to a power generator such that power is generated and the product gas mixture is depressurized through the turbine. In one or more embodiments, hydrogen is separated from the depressurized product gas mixture, forming a H₂ depleted gas mixture. In some embodiments, the hydrogen may be further refined to increase it purity. In one or more embodiments, CO₂ is separated from the depressurized product gas mixture, forming a CO₂ depleted gas mixture. In some embodiments, the carbon dioxide may be further refined to increase it purity. In one or more embodiments, the hydrogen is introduced into a subterranean storage formation. In one or more embodiments, the CO₂ is introduced into a second subterranean storage formation. In one or more embodiments, the injection of the oxygen-comprising gas mixture into the depleted reservoir may be a continuous process or a batch process.

Stored hydrogen can be utilized for various applications, such as the production of electricity or in pressure maintenance in gas reservoirs or reservoirs with a gas cap.

The embodiment methods allow for hydrocarbon reservoirs with low productivity to be further utilized for energy production and commercial utilization. It also allows for hydrogen to be produced and stored underground for later use. In addition, carbon dioxide may be stored underground for long term sequestration or for later use.

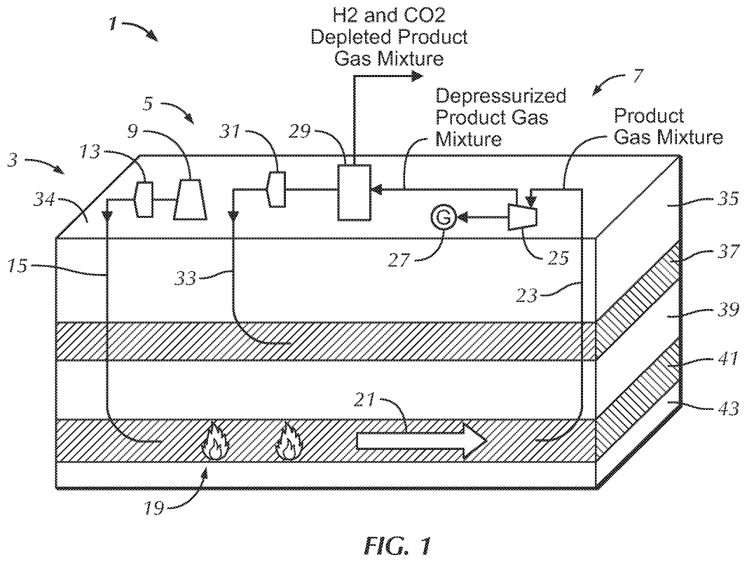

FIG. 1 is a representation of a well system having a depleted reservoir and a storage formation. Well system 1 has a number of wells traversing several layers of the Earth descending from the surface 34 including an overburden 35, a subterranean storage formation 37, an intermediate formation 39, and a depleted reservoir 41. An underburden 43 is present below the other layers. The wells shown in FIG. 1 include a gas injection wellbore 15 and a product gas wellbore 23, which both fluidly connect the surface 34 with the depleted reservoir 41. Gas injection wellbore 15 conveys an O₂ comprising gas mixture from the surface 34 to a portion of the depleted reservoir 41. Product gas wellbore 23 conveys a hot, pressurized product gas from a second portion of the depleted reservoir 41 to the surface 34. Well system 1 also includes hydrogen injection wellbore 33, which conveys pressurized hydrogen into a subterranean storage formation 37.

Well system 1 also includes a fire flood support system 3. In FIG. 1, fire flood support system 3 includes a source of power generation, such as solar panels 9. The power generation source is coupled to a compressor system 13, which use the power to compress a O₂ comprising gas mixture. During initial startup of the process, the source of power generation is external, such as solar panels. However, during operation, the fire flood support system 3 may be self-maintained through the product gas energy extraction system 7. The compressed O₂ comprising gas mixture is then introduced into the depleted reservoir 41 via the gas injection wellbore 15.

In FIG. 1, several actions are shown occurring. A fire flood 19 is present in a portion of the depleted reservoir 41. This in turn drives (arrow) hot, pressurized product gas 21 towards product gas wellbore 23. Each will be introduced in context forthcoming.

Well system 1 also includes a product gas energy extraction system 7. In FIG. 1, product gas energy extraction system 7 includes a product gas letdown turbine 25 coupled to the product gas wellbore 23. The product gas letdown turbine 25 is mechanically coupled to a generator 27 that is configured to generate electricity from the energy extracted by the turbine 25. The product gas wellbore 23 introduces the hot, pressurized product gas mixture into the turbine 25, which produces both a depressurized product gas mixture and electrical power (via generator 27). The depressurized product gas mixture is passed to an H₂ injection support system 5.

H₂ injection support system 5 is also part of well system 1. Upon receiving the depressurized product gas mixture, the gas mixture is introduced into chemical/gas separation processes 29. One of ordinary skill in the art appreciates that there are numerous chemical and gas separation processes comprising chemical/gas separation processes 29, but chemical/gas separation processes 29 are configured in H₂ injection support system 5 to extract and purify H₂ gas. The remainder of the gases—now H₂ depleted product gases—pass from the well system 1.

The H₂ gas in H₂ injection support system 5 is introduced into H₂ compressor 31, which is coupled to the surface entry of hydrogen injection wellbore 33. Pressurized H₂ gas is introduced into subterranean storage formation 37, where it remains until extracted.

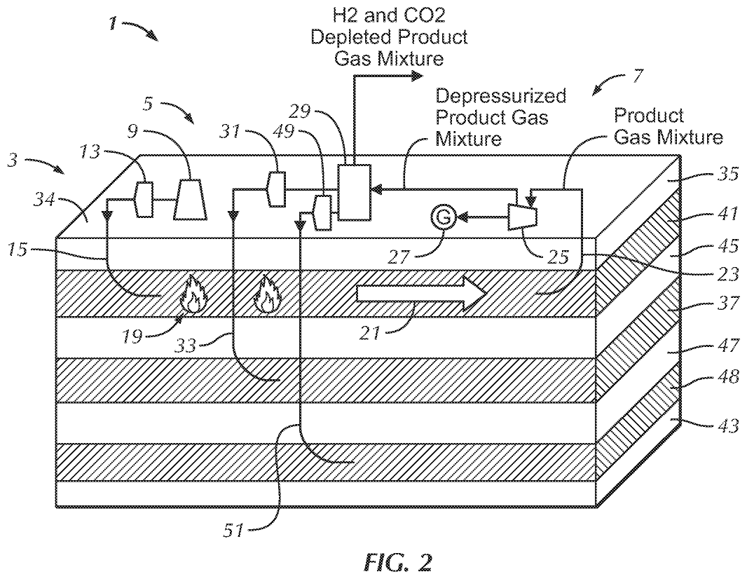

FIG. 2 is a representation of well system having a depleted reservoir and a plurality of storage formations, according to one or more embodiments. Well system 1 is similar to well system 1 of FIG. 1; however, there are a few differences in not only environmental structure but also surface processes.

In FIG. 2, well system 1 comprises at least four wells, an O₂ comprising gas injection wellbore 15, a hydrogen injection wellbore 33, a carbon dioxide injection wellbore 51, and a product gas wellbore 23. Wells in well system 1 traverse various layers of Earth descending from the surface, including an overburden 35, a depleted reservoir 41, an upper intermediate formation 45, a subterranean storage formation 37, a lower intermediate formation 47, and an additional subterranean storage formation 48. An underburden 43 is present beneath the other layers.

O₂ comprising gas injection wellbore 15 and the product gas wellbore 23 both fluidly connect the depleted reservoir with the surface, as in FIG. 1. Gas injection wellbore 15 conveys an O₂ comprising gas mixture from the surface 34 to a portion of the depleted reservoir 41. Product gas wellbore 23 conveys a hot, pressurized product gas from a second portion of the depleted reservoir 41 to the surface 34. Well system 1 also includes hydrogen injection wellbore 33, which conveys pressurized hydrogen into a subterranean storage formation 37, and carbon dioxide injection wellbore 51, which conveys pressurized carbon dioxide into an additional subterranean storage formation 48.

In FIG. 2, there is a fire flood 19 present in the depleted reservoir. Resulting from fire flood 19, product gas mixture 21 is driven toward product gas wellbore 23.

Well system 1 also includes a product gas energy extraction system 7. In FIG. 2, product gas energy extraction system 7 includes a product gas letdown turbine 25 fluidly connected to the product gas wellbore 23. The product gas letdown turbine 25 is mechanically coupled to a generator 27 that is configured to generate electricity from the energy extracted by the turbine 25. The product gas wellbore 23 introduces the hot, pressurized product gas mixture into the turbine 25, which produces both a depressurized product gas mixture and electrical power (via generator 27). The depressurized product gas mixture is passed to an H₂ injection support system 5.

The H₂ injection support system 5 is also part of well system 1. Upon receiving depressurized product gas mixture from the product gas letdown turbine 25, the depressurized product gas mixture is introduced into the chemical/gas separation processes 29. The chemical/gas separation processes 29 is configured to H₂ and CO₂ in separate streams from the depressurized product gas mixture and further purify them. The chemical/gas separation processes 29 may comprise various separation processes known to those skilled in the art that are capable of separating and purifying H₂ and CO₂ gas streams from the depressurized product gas mixture, leaving an H₂ and CO₂ depleted product gas mixture. The H₂ and CO₂ depleted product gas mixture then passes out of the well system 1.

The H₂ gas in H₂ injection support system 5 is introduced into H₂ compressor 31, which is coupled to the surface entry of hydrogen injection wellbore 33. Pressurized H₂ gas is introduced into subterranean storage formation 37, where it remains until extracted.

The CO₂ gas in the H₂ injection support system is introduced into CO₂ compressor 49, which is coupled to CO₂ injection wellbore 51. The CO₂ gas passes through the CO₂ injection wellbore 51 into the additional subterranean storage formation 48, where it is stored.

A “reservoir” is any subterranean geological hydrocarbon-bearing formation retaining, for example, crude oil, condensates, or natural gas. A reservoir may currently be under hydrocarbon production or may have previously been under hydrocarbon production. A “depleted” reservoir is a reservoir that has previously produced hydrocarbons. A depleted reservoir typically contains remaining or “residual” hydrocarbons, but these hydrocarbons are no longer being commercially produced by the reservoir. A “subterranean storage formation” is a subterranean geological formation capable of storing one or more fluids, such as gases, that is not the depleted reservoir from which these gases were produced. For purposes of this application, an overburden, an intermediate formation, and an underburden are considered to be impermeable to gas transport, that this, these formations do not support the migration of gas through their matrix.

Embodiment systems may have various configurations capable of providing power to components on the surface. Power may be able to be provided by sources that include, but are not limited to, solar panels, an electrical grid, waste heat, geothermal energy, and combustion of gases such as recovered light hydrocarbons or H₂S. There may be couplings configured to transfer power from one or more of these sources and one or more components on the surface. These may include components of a hydrogen injection support system, such as a compressor, or various pieces of equipment capable of separating hydrogen from the product gas mixture. There may be couplings between the various sources and one or more components of a fire flood support system, such as a gas compressor. In one or more embodiments, solar cells are electrically coupled to one or more components of the fire flood support system. Energy from gas streams on the surface may provide power to surface components from various systems, such as a hydrogen injection support system or a carbon dioxide injection support system. In one or more embodiments, waste heat may be available for transfer to separation processes. In one or more embodiments, power may be transferred from these sources to one or more of these components on the surface for execution of various steps of embodiment methods.

Elevated temperatures, that is, greater than surface or even normal subterranean formation temperatures, are required to carry out several thermochemical reactions in a depleted reservoir. Oxygen is introduced into the depleted reservoir via an injection well. The oxygen may be injected as a component of air, or as a component of air that has been partially enriched with oxygen such that the enriched air has a greater oxygen content than that of the atmosphere, that is greater than about 20 vol. % (volume percent) oxygen, such as greater than 30 vol. % oxygen, such as greater than 40 vol. % oxygen, such as greater than 50 vol. % oxygen, such as greater than 60 vol. % oxygen, such as greater than 70 vol. % oxygen, such as greater than 80 vol. % oxygen, such as greater than 90 vol. % oxygen, such as greater than 95 vol. % oxygen, such as greater than 98 vol. % oxygen, such as greater than 99 vol. % oxygen, such as greater than 99.9 vol. % oxygen. In one or more embodiments, oxygen comprising compounds may be used. In one or more embodiments, the oxygen-comprising gas mixture may be pressurized, that is, raised to a value greater than atmospheric pressure, prior to introduction into the depleted reservoir. In one or more embodiments, the pressure of the oxygen-comprising gas mixture may be greater than 100 psi (pounds per square inch). In one or more embodiments, the pressure of the oxygen-comprising gas mixture is in a range of from about 500 to about 1000 psi. Utilizing oxygen at elevated concentrations and pressures may require special oxygen-handling facilities and materials, including piping and isolation systems, which are appreciated by one of skill in the art.

Heat from the reservoir may be utilized to pre-heat the oxygen introduced into the reservoir. In one or more embodiments, the injection well and the production well utilize the same wellbore. In one or more embodiments, the wellbores are separate. In instances where the wells are the same, an injection tubing and a production tubing may be in the same well. This may be of value in some instances as the hot production gas may pre-heat the oxygen-comprising gas mixture as it descends into the depleted formation. In instances where the wellbores are different, a heat exchanger on the surface, such as in the gas turbine, may be utilized to preheat the oxygen before introduction. Oxygen injection and removal may be performed in different branches in the same well, as the fire flood would serve to help push reaction products away from the location of ignition.

Water and hydrocarbons are typically both present in a depleted reservoir. After injection of oxygen-comprising gas mixture into the depleted reservoir, in one or more embodiments a fire flood is initiated in a portion of the depleted reservoir. The various hydrocarbons in the presence of pressurized oxygen undergo in-situ combustion within the depleted reservoir, also known as a fire flood. In a fire flood, a fire is ignited and a fire front moves through the depleted reservoir as oxygen continues to be injected. This combination serves to push fluids inside the depleted reservoir toward another well, where they can be recovered.

In the depleted reservoir where the fire flood is, combustion of hydrocarbons, the generation of steam from formation water, the reduction of viscosity of otherwise viscous hydrocarbons, the cracking of the reservoir to release trapped heated fluids, and the cracking of long-carbon hydrocarbons into smaller-carbon hydrocarbons, which are more mobile, occurs simultaneously. The resulting fire flood may substantially increase the temperature in the depleted reservoir, allowing various chemical reactions to occur and forming the product gas mixture. Both thermochemical and catalytic reactions may occur, as metal oxides, salts, and other organic and inorganic species are present that may support a number of chemical conversions, both organic and inorganic. These chemical reactions may produce a mixture of gases that may include, but are not limited to, CO₂, H₂, H₂O, O₂, N2, CO, H₂S, CH₄, ethane, propane, butanes, and heavier alkanes and cycloalkanes; light olefins, including ethylene, propylene, butylenes, and heavier alkylolefins; and potentially aromatics and alkyl aromatics, such as benzene. In one or more embodiments, other gas products, such as SOx, NOx, light aromatics, and light olefins, may be produced and be present in the product gas mixture. In one or more embodiments, olefins and diolefins may be produced due to the thermal cracking of the saturated hydrocarbons. In addition, there may be other compounds present in the mixture of gases that are not listed.

Several different chemical reactions may occur in the oxygen-rich environment in the presence of elevated temperatures and metal oxides. Representative reactions that may occur include, but are not limited to, Formulas 1-5:

$${C}_{n} {H}_{m} + \frac{n}{2} {O}_{2} \to nCO + \frac{m}{2} {H}_{2} \qquad ( Formula 1 )$$

$$CO + {H}_{2} O \to {H}_{2} + {CO}_{2} \qquad ( Formula 2 )$$

$${C}_{n} {H}_{m} + {nH}_{2} O \to nCO + ( n + \frac{m}{2} ) {H}_{2} \qquad ( Formula 3 )$$

$${CO}_{2} + 4 {H}_{2} \to {CH}_{4} + 2 {H}_{2} O \qquad ( Formula 4 )$$

$${C}_{m} {H}_{n} + ( \frac{n}{4} + m ) {O}_{2} \to {mCO}_{2} + \frac{n}{2} {H}_{2} O \qquad ( Formula 5 )$$

where m and n are positive integers. Formula 1 reflects the partial oxidation of hydrocarbons. Formula 2 reflects a water-gas shift reaction. Formula 3 reflects a steam-reforming reaction. Formula 4 reflects the Sabatier reaction, which may occur in elevated temperature environments in the presence of a metal, such as nickel, or metal oxides. Formula 5 refers to oxidative combustion of a hydrocarbon. Additional chemical reactions may occur as a result of the introduction of oxygen and the fire flood into the depleted reservoir. In one or more embodiments, partial oxidation of hydrocarbon into CO and H₂ mainly comes from stoichiometrically insufficient O₂. In one or more embodiments, water or steam may be injected along with oxygen to increase production of hydrogen. In one or more embodiments, additional catalysts may be used as a supplement to the natural catalysts present in the formation. These catalysts may include, but are not limited to, partial oxidation catalysts such as Pt, Ni, Pd for combustion of hydrocarbons into CO and H₂O. Other catalysts known to those skilled in the art may also be used.

Once the fire flood starts, a product gas mixture may form as a product of the reactions. The product gas mixture may then be produced from the reservoir. This extraction may be performed through a separate well from the injection well, may be produced from the same well but a separate production tubing, as previously described, based upon the configuration of the well system, or both. The fire flood in conjunction with the production serves to create a fluid momentum to drive the product gas mixture (and potentially any now-mobilized hydrocarbons) towards the production tubing. This reaction and production may cause the product gas mixture to have not only an elevated temperature, but due to the confined environment also an elevated pressure, which assists in production.

In one or more embodiments, energy may be extracted from the product gas mixture. For example, the product gas mixture, which has an elevated temperature, may be passed through a gas turbine for the purpose of energy production, such as for creating electricity. An example of such a turbine may be an integrated gas turbine (IGT), where heat energy is converted into mechanical energy by passing the elevated temperature gas through a turbine but also the same gas through a heat exchanger to create high-pressure steam. The product gas mixture from the wellbore is of sufficient heat and volume to drive a turbine and generate mechanical energy. The resultants are not only the production of power in some form but also a cooler, depressurized product gas mixture. Passing the product gas mixture through a turbine results not only in a temperature reduction but also a pressure reduction having translated the thermal energy of the gas into mechanical energy. Other methods for extracting energy from the product gas mixture may also be employed, such as heat exchangers to create high-pressure steam, as previously suggested, or to facilitate chemical reactions in a reaction vessel or combustion of the product gas to provide energy for electrical energy generation. Heat exchangers may also be utilized to provide process heat from the product gas mixture. In one or more embodiments, the energy produced from the product gas mixture may be stored through various means. These may include, but are not limited to, compressed air energy storage, water elevation energy storage, batteries, supercapacitors, and other electrical energy storage.

The cooler, depressurized product gas mixture is introduced into one or more separation processes to extract useful chemical components from the product gas mixture. Suitable separation processes known to those skilled in the art may include, but are not limited to, dehydration, pressure swing adsorption, and temperature swing absorption. Energy from the gas turbine may be utilized in one or more separation processes.

In one or more embodiments, both a hydrogen-rich gas mixture and a hydrogen-poor product gas mixture are produced from the depressurized product gas mixture. During the one or more separation processes, hydrogen may be separated from the depressurized product gas mixture to form a hydrogen-rich gas mixture. This hydrogen-rich gas mixture comprises a greater concentration of hydrogen than the product gas mixture. In one or more embodiments, the hydrogen-rich gas mixture may substantially free of other components. In one or more embodiments, the hydrogen-rich gas mixture has a purity in a range of greater than 50% hydrogen, such as greater than 60%, such as greater than 70%, such as greater than 80%, such as greater than 90%, such as greater than 95%, such as greater than 98%, such as greater than 99%, such as greater than 99.9%. In one or more embodiments, the hydrogen-rich gas mixture may comprise components other than hydrogen, including, but not limited to, CO₂, CO, H₂O, N₂, small C2+ hydrocarbons, H₂S, and NO₂.

In one or more embodiments, both a carbon dioxide-rich gas mixture and a carbon dioxide-poor product gas mixture are produced from the depressurized product gas mixture. During the one or more separation processes, carbon dioxide may be separated from the depressurized product gas mixture to form a carbon dioxide-rich gas mixture. This carbon dioxide-rich gas mixture comprises a greater concentration of carbon dioxide than the product gas mixture. In one or more embodiments, the carbon dioxide-rich gas mixture may comprise components other than carbon dioxide. In one or more embodiments, the carbon dioxide-rich gas mixture may substantially free of other components. In one or more embodiments, the carbon dioxide-rich gas mixture has a purity in a range of greater than 50% carbon dioxide, such as greater than 60%, such as greater than 70%, such as greater than 80%, such as greater than 90%, such as greater than 95%, such as greater than 98%, such as greater than 99%, such as greater than 99.9%. In one or more embodiments, if one or more of the separation processes includes amine absorption, then the carbon dioxide-rich gas mixture may typically have a purity that is greater than about 90%.

Other components may be separated from the gas mixture as well, such as water; light hydrocarbons (LHC), such as alkanes, olefins, and aromatics; and other gases and liquids. In one or more embodiments, light hydrocarbons may be recovered during the separation processes. The light hydrocarbons, once recovered, may be recycled, combusted, and then directed back to the turbine for more energy production. In one or more embodiments, energy from combustion of the light hydrocarbons may be used to power surface processes, such as separation. In one or more embodiments, light hydrocarbons may be injected into the depleted reservoir with the oxygen-comprising gas mixture. In one or more embodiments, one or more of the gas streams may be put through a scrubber to remove contaminants. In one or more embodiments, if hydrogen or carbon dioxide are going to be separated from the gas mixture via membranes, it may be desired to separate out various heavier components prior to separating hydrogen or carbon from the gas mixture in order to prevent fouling in the membranes.

After separation from the product gas mixture, the hydrogen-rich gas mixture may be introduced into one or more subterranean storage formations. Hydrogen may be transported through pipelines and injected into a subterranean storage formation. The subterranean storage formation is any type of subterranean geological formation that is configured to hold a gas for an extended period without detectable leakage. This may include, but is not limited to, depleted hydrocarbon reservoirs, other hydrocarbon reservoirs, shallow neogene aquifers, and salt caverns. In order to be able to store a gas, a subterranean storage formation is bound both above and below by formations less permeable to the gas than the subterranean storage formation. These formations should be substantially impermeable to the gas so as to prevent detectable leakage. In one or more embodiments, less than 0.1% annual loss of hydrogen from the subterranean storage formation may be permissible. In one or more embodiments, less than 0.01% annual loss of hydrogen from the subterranean storage formation may be permissible. These intermediate formations would hinder migration of the gas from the subterranean storage formation. In other words, the subterranean storage formations are bound by rock layers with nearly zero permeability to the stored gas. In one or more embodiments, the permeability of hydrogen in the intermediate formations, both above and below the subterranean storage formation, may be less than 0.1 millidarcy. In contrast, the subterranean storage formation needs to have a permeability to the stored gas that is great enough to permit introduction and mobility through the subterranean storage formation. In one or more embodiments, the permeability of the subterranean storage formation to hydrogen may be greater than 1 millidarcy.

Hydrogen or other gases may be stored in a subterranean storage formation either above or below the depleted reservoir in which the fire flood is present. The hydrogen gas would then be able to be stored for an extended time and may be produced in the future. In one or more embodiments, hydrogen may be stored in a subterranean storage formation above the depleted reservoir, as hydrogen is a light gas and may migrate upward naturally. In one or more embodiments, the subterranean storage formation where hydrogen is stored may be a gas reservoir or in a reservoir with a gas cap. The stored hydrogen may be used to increase pressure in the reservoir. In addition, when the reservoir is depleted, the gas-cap may be ‘drained’ and produced. The stored hydrogen mixed with the other gases from the reservoir may then be produced and utilized.

Once stored, the hydrogen-rich gas may be removed from the subterranean storage formation and produced to the surface at any time. The hydrogen-rich gas mixture may be further refined utilizing specialized hydrogen-based processes that are known to those skilled in the art. These techniques may include, but are not limited to, dehydration, pressure swing adsorption, temperature swing adsorption, and membrane separation. Separation of hydrogen from other materials may take the form of a combination of these or other techniques in order to obtain hydrogen of sufficient purity for use in the intended applications.

After separation from the product gas mixture, the carbon dioxide-rich gas mixture may be introduced into one or more subterranean storage formations, similarly as the prior description of the storage of hydrogen-rich gas mixture. Carbon dioxide or other gases may be stored in a subterranean storage formation either above or below the depleted reservoir in which the fire flood is present. Once stored, the carbon dioxide-rich gas mixture may be removed from the subterranean storage formation and produced to the surface at any time. The CO₂ may be stored in an additional subterranean storage formation separate from the hydrogen-rich gas mixture. The carbon dioxide-rich gas mixture may be produced and utilized in supercritical CO₂ enhanced oil recovery or other applications. In one or more embodiments, carbon dioxide may be reacted with various minerals, such as silicates, for the purpose of carbon capture and sequestration.

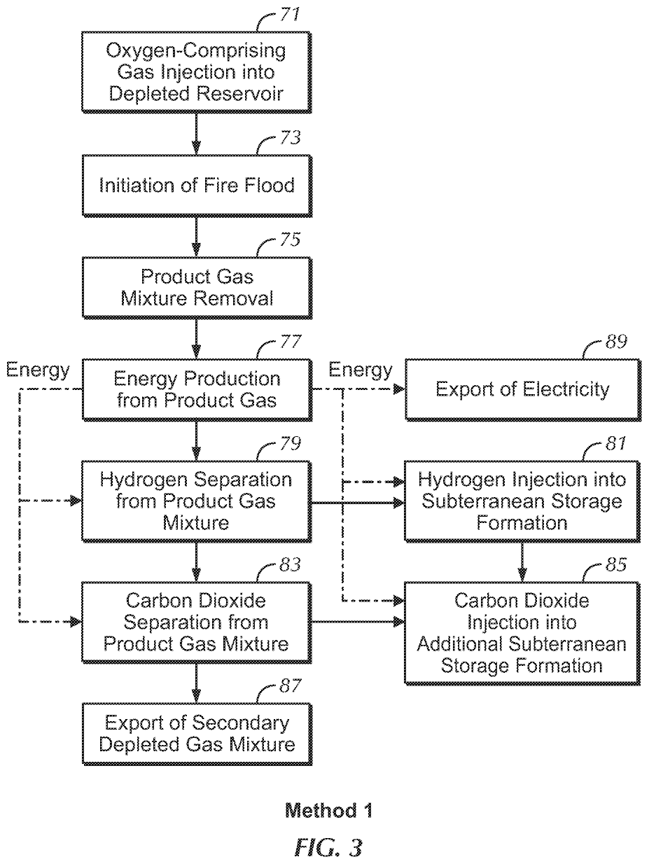

FIG. 3 is a representation of one embodiment of a method of hydrogen production and storage, method 1. In this embodiment, an O₂ comprising gas mixture is injected into a depleted reservoir 71. A fire flood is initiated 73, producing a product gas mixture that is subsequently removed from the depleted reservoir 75. In method 1, energy is extracted from the product gas mixture by various means known to those skilled in the art 77. These may include the use of a gas turbine for producing electricity, extracting heat, or both, from the product gas mixture. In method 1, as shown in FIG. 3, this energy is used in one or more processes including hydrogen separation 79, carbon dioxide separation 83, hydrogen injection into a subterranean storage formation 81, and carbon dioxide injection into the additional subterranean storage formation 85. In method 1, electricity produced during energy production from the product gas is then exported 89. After energy extraction from the product gas 77, hydrogen is then separated from the product gas mixture 79, leaving behind a depleted product gas mixture, before being injected into the subterranean storage formation 81. In FIG. 3, carbon dioxide is then separated from the depleted product gas mixture 83, producing a secondary depleted gas mixture, before being injected into an additional subterranean storage formation 85. The secondary depleted product gas mixture may then be exported for further processing 87.

Method 1 is one embodiment. Other embodiments for hydrogen production and storage are also possible, in addition to that depicted in FIG. 3. For example, other configurations for optional energy extraction from the product gas mixture may be employed. In addition, other configurations may also be possible, including those described in other embodiments herein.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A method for generating and recovering hydrogen from a depleted reservoir, comprising:
introducing oxygen into a depleted reservoir;
inducing a fire flood in the depleted reservoir to generate a gas mixture comprising hydrogen;
removing the gas mixture from the depleted reservoir;
recovering energy from the gas mixture;
separating a portion of the hydrogen from the gas mixture to create a depleted gas mixture and a hydrogen-rich gas mixture; and
introducing the hydrogen-rich gas mixture into a subterranean storage formation.

2. The method according to claim 1, where carbon dioxide is further separated from the depleted gas mixture, producing a carbon dioxide-rich gas mixture and a secondary depleted gas mixture.

3. The method according to claim 2, where the separated carbon dioxide is introduced into an additional subterranean storage formation.

4. The method according to claim 1, further comprising introducing an oxygen-comprising gas mixture into the depleted reservoir.

5. The method according to claim 1, where the hydrogen is generated via partial oxidation of hydrocarbon in the depleted reservoir.

6. The method according to claim 1, where the hydrogen is generated via water gas shift reaction in the depleted reservoir.

7. The method according to claim 1, where energy is recovered from the gas mixture through the use of a gas turbine connected to a generator.

8. The method according to claim 1, where one or more additional components are separated from the depleted gas mixture, wherein one or more additional components are selected from the group consisting of light hydrocarbons or hydrogen sulfide.

9. The method according to claim 8, where energy is recovered from the one or more additional components from combustion or combustion products of the one or more additional components.

10. The method according to claim 1, where light hydrocarbons are introduced into the depleted reservoir.

11. A method for producing and storing hydrogen gas comprising:
introducing oxygen into a depleted reservoir via an oxygen-comprising gas mixture;
inducing a fire flood in the depleted reservoir such that at least one chemical reaction occurs to generate a gas mixture comprising hydrogen and carbon dioxide;
removing the gas mixture from the depleted reservoir;
separating some of the produced hydrogen gas and carbon dioxide from the gas mixture to create a hydrogen-rich gas mixture, a carbon dioxide-rich gas mixture, and a secondary depleted gas mixture;
injecting the hydrogen-rich gas mixture into a subterranean storage formation; and
injecting the carbon dioxide-rich gas mixture into an additional subterranean storage formation.

12. A system comprising:
a depleted reservoir comprising hydrocarbons;
a subterranean storage formation, where the subterranean storage formation is bounded on at least one side by an intermediate formation, and where hydrogen gas is substantially present in the subterranean storage formation;
a fluid pathway between the depleted reservoir and the subterranean storage formation; and
a wellbore comprising a wall that traverses the subterranean storage formation and the depleted reservoir.

13. The system according to claim 12 further comprising a second subterranean storage formation that is bounded on one side by a second intermediate formation, wherein carbon dioxide is substantially present in the second subterranean storage formation.

14. The system according to claim 12 further comprising a chemical/gas separation process that is materially connected to the subterranean storage formation.

15. The system according to claim 12 further comprising a turbine that is materially connected to the depleted reservoir.
